(19) United States
(12) Patent Application Publication
(10) Pub. No.: US 2026/0133551 A1
(43) Pub. Date: May 14, 2026

(54) SYSTEM AND METHOD FOR WIDE-AREA CLOUD MANUFACTURING INDUSTRIAL SERVICE BASED ON INTERNET OF THINGS LARGE MODEL

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/437,240

(22) Filed: Dec. 30, 2025

(30) Foreign Application Priority Data
Nov. 21, 2025 (CN) 202511715522.4

(51) Int. Cl. G05B 15/02

(52) U.S. Cl. CPC G05B 15/02

(57) ABSTRACT

Provided is a wide-area cloud manufacturing industrial service system and method based on an Internet of Things large model. The system includes a service cloud platform and a user platform. The service cloud platform is configured to: acquire a constraint indicator; determine first service data from historical service data corresponding to a user based on the constraint indicator; in response to the first service data satisfying a user demand, display the first service data to the user; in response to the first service data not satisfying the user demand, determine a candidate service pool based on the constraint indicator and the user demand, and generate a matching degree between each candidate service data and the user demand; and take one or more candidate service data whose matching degree satisfies a preset matching condition as one or more second service data, and present the second service data to the user.

### CROSS-REFERENCE TO RELATED APPLICATIONS

This application claims priority of Chinese Patent Application No. 202511715522.4, filed on November 21, 2025, the entire contents of each of which are hereby incorporated by reference.

### TECHNICAL FIELD

The present disclosure relates to the field of manufacturing service, and particularly relates to a wide-area cloud manufacturing industrial service system and method based on an Internet of Things (IoT) large model.

### BACKGROUND

With the acceleration of industrial digitalization, manufacturing enterprises have generally migrated processes such as research and development, design, production, warehousing, and logistics to the cloud, forming a wide-area cloud manufacturing ecosystem that spans geographical locations and organizations. The wide-area cloud manufacturing leverages the Industrial Internet of Things (IoT) to abstract distributed resources such as design, machining, inspection, and logistics into tradable services. These services are made available on a cloud platform for on-demand access by enterprises across different regions and of varying scales, enabling collaborative resource utilization and shared capabilities. However, different manufacturing enterprises use different terms to express their needs. They also have different production capabilities. Because of this, the existing wide-area cloud manufacturing services cannot achieve accurate matching in a short time.

Therefore, there is a pressing need for a wide-area cloud manufacturing industrial service system and method based on an IoT large model. The system and method acquire the actual needs of manufacturing enterprises, providing precisely matched service data, to support the high-quality operation of the wide-area cloud manufacturing industrial service.

### SUMMARY

One or more embodiments of the present disclosure provide a wide-area cloud manufacturing industrial service system based on an Internet of Things (IoT) large model. The system includes a service cloud platform and a user platform. The service cloud platform is configured to acquire a constraint indicator through the user platform. The service cloud platform is configured to determine the first service data from historical service data corresponding to a user based on the constraint indicator. In response to a determination that the first service data satisfies a user demand, the service cloud platform is configured to display the first service data to the user through the user platform. In response to a determination that the first service data does not satisfy the user demand, the service cloud platform is configured to determine a candidate service pool from a service database based on the constraint indicator and the user demand, and generate a matching degree between each of a plurality of candidate service data in the candidate service pool and the user demand. The service cloud platform is further configured to take one or more candidate service data whose matching degree satisfies a preset matching condition as one or more second service data, and present the one or more second service data to the user through the user platform.

One or more embodiments of the present disclosure provide a wide-area cloud manufacturing industrial service method based on an IoT large model. The method is performed by a service cloud platform of a wide-area cloud manufacturing industrial service system based on an IoT large model. The method comprising: acquiring a constraint indicator through a user platform; determining first service data from historical service data corresponding to a user based on the constraint indicator; in response to a determination that the first service data satisfies a user demand, displaying the first service data to the user through the user platform; in response to a determination that the first service data do not satisfy the user demand, determining a candidate service pool from a service database based on the constraint indicator and the user demand, and generating a matching degree between each of a plurality of candidate service data in the candidate service pool and the user demand; and taking one or more candidate service data whose matching degree satisfies a preset matching condition as one or more second service data and presenting the one or more second service data to the user through the user platform.

The present disclosure provides beneficial effects including but not limited to: (1) by using the wide-area cloud manufacturing industrial service system based on an IoT large model, the actual demands of manufacturing enterprises can be acquired, precisely matched service data can be provided to manufacturing enterprises, and the high-quality operation of the wide-area cloud manufacturing industrial services can be supported. (2) By acquiring the user demands and the constraint indicators, the system can quickly filter service data that meets user demand, avoiding complex searches in massive datasets, thereby significantly improving matching speed. When the service data obtained through fast filtering does not satisfy the user demand, the system can further filter service data with a higher matching degree to the user, thereby further improving the user experience. (3) By leveraging a large language model, keywords can be rapidly extracted from the original input information of the user. Based on these keywords, the field generation instructions are intelligently created using a predefined fragment library. Then, through an industry-specific large model, predefined fields that guide the user in the information interaction can be quickly obtained. This staged and model-specific processing approach avoids the computational burden of using a single model to process massive data, while ensuring the accuracy of the final generated preset fields.

### BRIEF DESCRIPTION OF THE DRAWINGS

The present disclosure will be further described in the form of exemplary embodiments, which will be described in detail with reference to the accompanying drawings. These embodiments are not intended to be limiting, and identical reference numerals denote identical structures throughout, wherein:

FIG. 1 is a schematic diagram of platforms of a wide-area cloud manufacturing industrial service system based on an Internet of Things (IoT) large model according to some embodiments of the present disclosure;

FIG. 2 is an exemplary flowchart illustrating a wide-area cloud manufacturing industrial service method based on an IoT large model according to some embodiments of the present disclosure;

FIG. 3 is an exemplary flowchart of acquiring the user demand and the constraint indicator according to some embodiments of the present disclosure;

FIG. 4 is an exemplary schematic diagram of a matching model according to some embodiments of the present disclosure.

### DETAILED DESCRIPTION

For a clearer explanation of the technical solutions of the embodiments of the present disclosure, a brief introduction to the accompanying drawings used in the description of the embodiments is provided below. It will be apparent that the accompanying drawings in the following description are only some examples or embodiments of the present disclosure, and that the present disclosure may be applied to other similar scenarios in accordance with these drawings without creative labor for those skilled in the art. Unless clearly apparent from the language context or otherwise stated, the same reference numerals in the figures denote the same structures or operations.

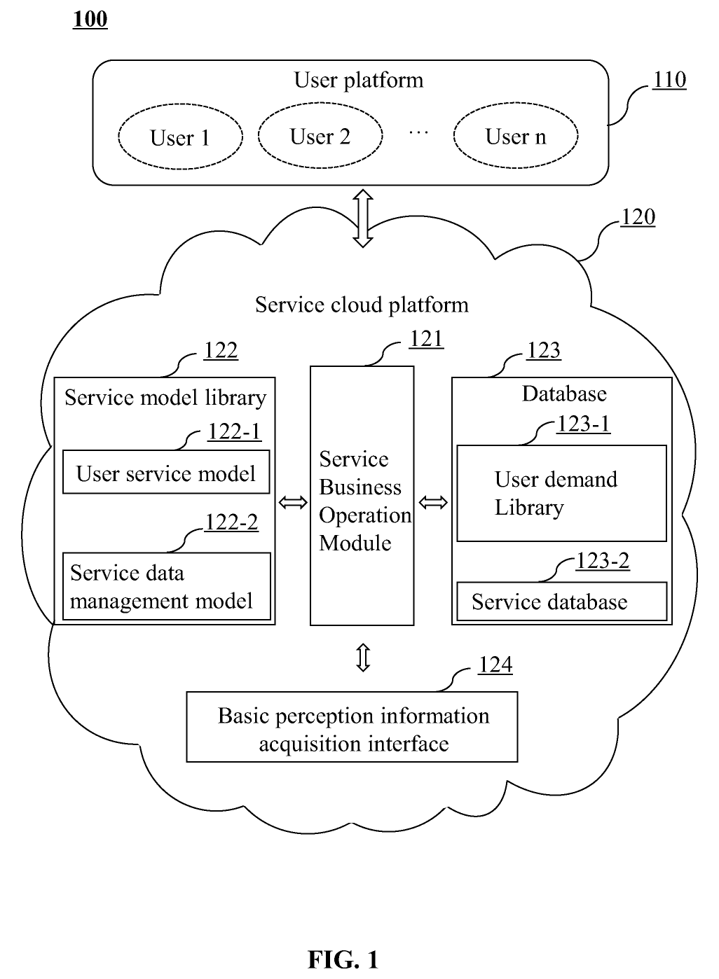

FIG. 1 is a schematic diagram of platforms of a wide-area cloud manufacturing industrial service system based on an Internet of Things (IoT) large model according to some embodiments of the present disclosure.

In some embodiments, as shown in FIG. 1, a wide-area cloud manufacturing industrial service system 100 based on an IoT large model may include a user platform 110 and a service cloud platform 120.

In some embodiments, the user platform 110 and the service cloud platform 120 are communicatively connected. The user platform 110 and the service cloud platform 120 may perform the information interaction.

In some embodiments, the user platform 110 may be communicatively connected to user terminals of a plurality of users (such as user 1, user 2, ..., user n, etc.). The user types include enterprises, individuals, etc. The user platform 110 may receive input information from a plurality of users, such as basic perception information.

In some embodiments, the user platform 110 may include servers and user terminals. The users may upload information to the server through user terminals such as computers.

In some embodiments, the service cloud platform 120 may be able to send generated service data, such as first service data, to the user platform. The service cloud platform may include cloud platforms such as public cloud, hybrid cloud, multi-tier cloud, or any combination thereof.

In some embodiments, the service cloud platform 120 includes a service business operation module 121, a service model library 122, a database 123, and a basic perception information acquisition interface 124, which are communicatively connected.

In some embodiments, the service cloud platform 120 is configured to acquire a constraint indicator through the user platform and determine first service data from historical service data corresponding to the user based on the constraint indicator. The service cloud platform 120 is further configured to, in response to a determination that the first service data satisfies a user demand, display the first service data to the user through the user platform. The service cloud platform 120 is further configured to, in response to a determination that the first service data does not satisfy the user demand, determine a candidate service pool from a service database based on the constraint indicator and the user demand, and generate a matching degree between each of a plurality of candidate service data in the candidate service pool and the user demand; and take one or more candidate service data whose matching degree satisfies a preset matching condition as one or more second service data, and present the one or more second service data to the user through the user platform.

In some embodiments, the service business operation module 121 is configured to process or allocate data, information, or instructions received by the service cloud platform 120.

In some embodiments, the service model library 122 is configured to manage information related to the user. The service model library 122 may include a user service model 122-1 and a service data management model 122-2. The user service model 122-1 may be a model of information related to the industry to which the user belongs, such as an industry large model. The service data management model 122-2 is configured to manage information related to service data, such as the evaluation information.

In some embodiments, the database 123 is configured to store data, information, or instructions received by the service cloud platform. The database 123 may include a user demand library 123-1 and a service database 123-2. The user demand library 123-1 is configured to store information related to the user, such as the user demand and the evaluation information. The service database 123-2 is configured to store service data, such as the candidate service data and the historical service data.

In some embodiments, the basic perception information acquisition interface 124 is configured to provide a data transmission channel between the user platform and the cloud platform. The basic perception information acquisition interface 124 may be a network communication interface.

In some embodiments, the service cloud platform 120 may include a processor and a memory. The service business operation module 121 is arranged on the processor. The processor includes a central processing unit (CPU), an application-specific integrated circuit (ASIC), a controller, a microcontroller unit, a microprocessor, or the like, or any combination thereof

In some embodiments, the service model library 122 and the database 123 may be arranged within the memory. In some embodiments, the memory may be integrated within the processor or may be disposed in a cloud.

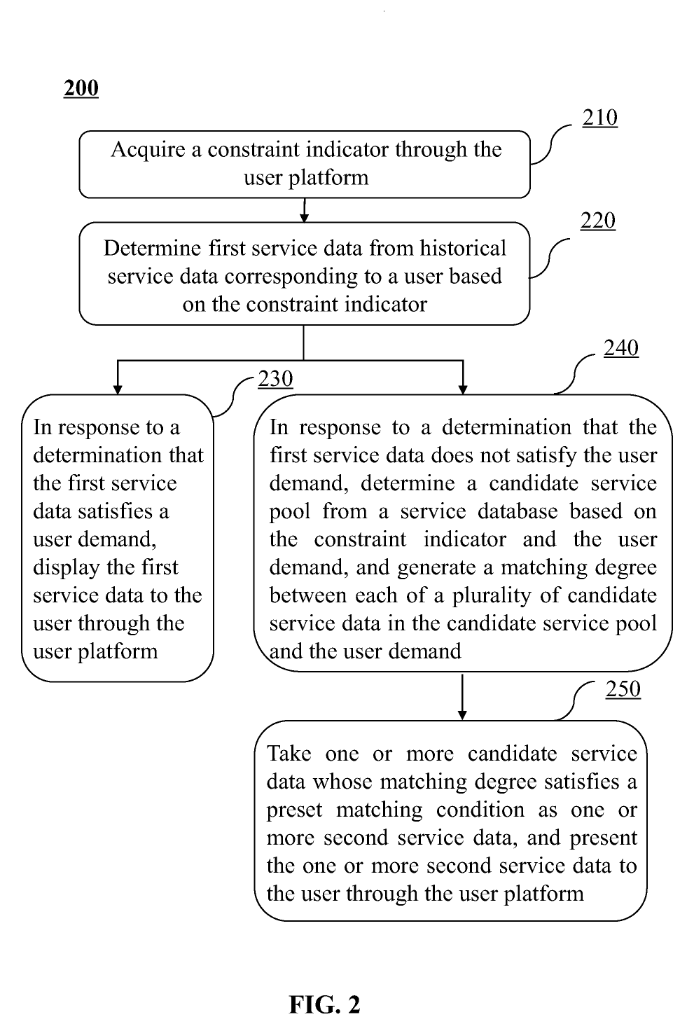

More descriptions regarding the above content may be found in FIGS. 2-4 and relevant descriptions thereof.

In some embodiments of the present disclosure, by using the wide-area cloud manufacturing industrial service system 100 based on the IoT large model, the actual demand of manufacturing enterprises can be acquired, precisely matched service data can be provided to manufacturing enterprises, and the high-quality operation of the wide-area cloud manufacturing industrial services can be supported.

FIG. 2 is an exemplary flowchart illustrating a wide-area cloud manufacturing industrial service method based on an IoT large model according to some embodiments of the present disclosure. In some embodiments, a process 200 may be performed by a service cloud platform. As shown in FIG. 2, the process 200 includes the following steps.

In 210, acquire a constraint indicator through the user platform.

More descriptions regarding the user and the user platform may be found in FIG. 1 and relevant descriptions thereof.

The constraint indicator refers to a limiting factor provided by the user for the service data. For example, the constraint indicator may include limitations on the type, industry, and/or category of service data. Merely by way of example, when a user inputs "articulated robotic arm", the "articulated" is a constraint indicator for the robotic arm.

The service data refers to information or data provided to the user. For example, when a user inquires about the specifications of a machine tool, the service data may include a maximum swing diameter, a maximum machining length, and a spindle bore diameter of the machine tool.

In some embodiments, the service cloud platform may extract information uploaded by the user through the user platform by ways such as speech recognition, text recognition, or image recognition, and identify one or more constraint indicators from the information.

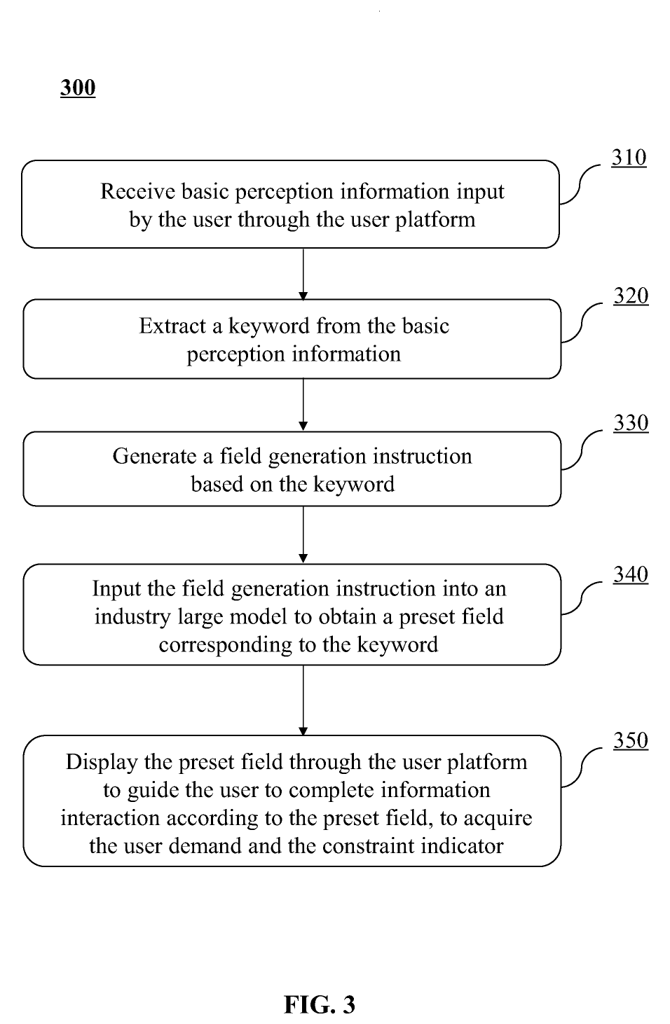

In some embodiments, the service cloud platform may further guide the user to complete the information interaction according to the preset fields, thereby acquiring the constraint indicator. More descriptions regarding this part of the content may be found in FIG. 3 and relevant descriptions thereof.

In 220, determine first service data from historical service data corresponding to the user based on the constraint indicator.

The historical service data refers to service data provided by the service cloud platform to the current user during historical periods.

In some embodiments, the historical service data may include the first service data and the second service data presented to the user by the service cloud platform through the user platform during historical periods. More descriptions regarding the second service data may be found in step 240 and the relevant descriptions thereof.

In some embodiments, the service cloud platform may extract the historical service data corresponding to the user from the service database based on the identity features of the user, such as name or registration information. More descriptions regarding the service database and other databases of the service cloud platform may be found in FIG. 1 and the relevant descriptions thereof.

The first service data refers to service data that includes the constraint indicator.

In some embodiments, the service cloud platform may filter the historical service data that includes the constraint indicator from the historical service data corresponding to the user, and take the filtered historical service data as the first service data. For example, when a user inquires about information regarding an "articulated robotic arm" and the constraint indicator is "articulated", the processor determines the historical service data that includes "articulated" and is related to robotic arms as the first service data.

In some embodiments, the first service data may include a case of satisfying the user demand and a case of not satisfying the user demand.

In 230, in response to a determination that the first service data satisfies the user demand, display the first service data to the user through the user platform.

In some embodiments, the correspondence between the first service data and the user demand includes a case in which the first service data satisfies the user demand and a case in which the first service data does not satisfy the user demand.

The user demand refers to information related to the service data that the user expects to obtain. In some embodiments, the user demand may include the type of service data, the domain of the service data, and/or the level of detail of the service data that the user expects to receive from the service cloud platform.

In some embodiments, the service cloud platform may acquire the user demand of the user at a historical time from the user demand library as the current user demand.

In some embodiments, the service cloud platform may further guide the user to complete the information interaction according to the preset fields, thereby acquiring the user demand. More descriptions regarding this part of the content may be found in FIG. 3 and relevant descriptions thereof.

In some embodiments, the first service data satisfying the user demand may be that the similarity between the type of service data in the first service data and the type of service data in the user demand is not less than a first similarity threshold, and the evaluation information of the user for the first service data is not less than an evaluation threshold. The first similarity threshold and the evaluation threshold may be preset based on historical experience. More descriptions regarding the evaluation information may be found in the following text and the relevant descriptions thereof.

In some embodiments, the first similarity threshold may be positively correlated with the average historical access count of the preset field. More descriptions regarding the preset field may be found in FIG. 3 and relevant descriptions thereof. The higher the average historical access count of the preset field, the higher the confidence level of the preset field. By increasing the first similarity threshold according to the average historical access count, the likelihood that the filtered first service data satisfies the user demand is able to be improved.

The similarity of the types of service data may be represented by the ratio of the number of identical types of service data to the total number of types of service data in the user demand. The identical types of service data refer to service data types in the first service data that are the same as those in the user demand. For example, if the service data types in the user demand are A, B, and C, and the service data types in the first service data are A, B, and D, then the similarity of service data types is 66%, where A, B, C, and D represent different service data types.

The evaluation information may be the degree of satisfaction of user with the first service data or the second service data.

In some embodiments, the evaluation information may include ratings corresponding to data items included in the service data. The rating indicates the degree of satisfaction of the user with the data item, where a higher rating corresponds to a higher level of satisfaction. For example, if the first service data includes the maximum swing diameter and the maximum machining length of the machine tool, the evaluation information may include a rating for the maximum swing diameter and a rating for the maximum machining length by the user. The data items included in the service data may be data of the different service data types.

Since the first service data is the service data from a historical time, the service cloud platform may obtain the historical evaluation information corresponding to the first service data through the service data management model.

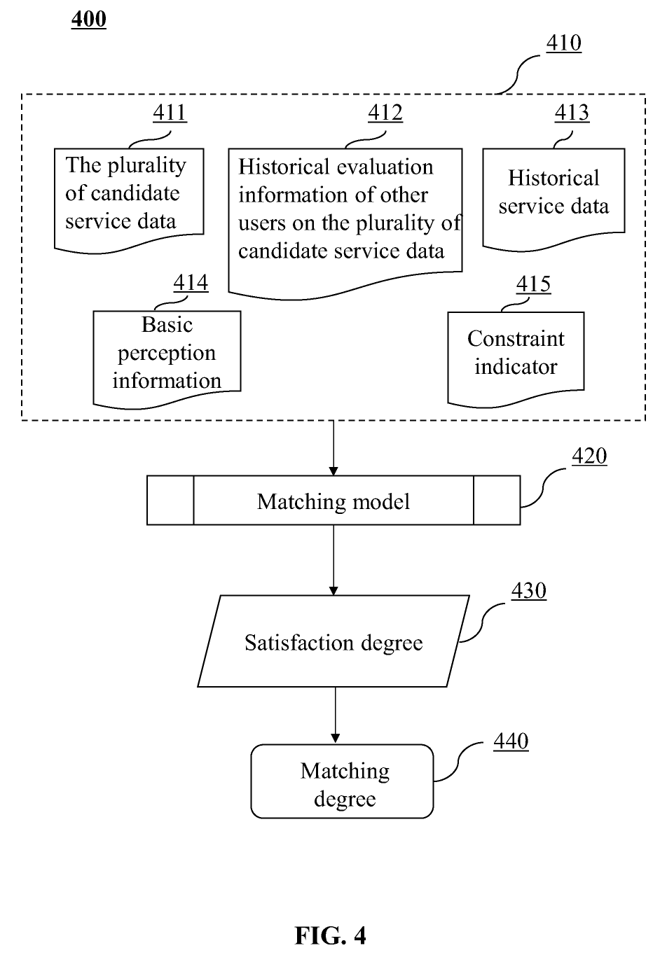

More descriptions regarding the acquisition of the evaluation information may be found in FIG. 4 and the relevant descriptions thereof.

In some embodiments, in response to a determination that the first service data satisfies the user demand, the service cloud platform may display the first service data to the user through the user platform.

In 240, in response to a determination that the first service data does not satisfy the user demand, determine a candidate service pool from a service database based on the constraint indicator and the user demand, and generate a matching degree between each of a plurality of candidate service data in the candidate service pool and the user demand.

In some embodiments, the first service data not satisfying the user demand may be that the similarity between the type of service data in the first service data and the type of service data in the user demand is lower than the first similarity threshold, and the evaluation information of the user for the first service data is lower than the evaluation threshold.

The candidate service pool refers to a data set containing a plurality of candidate service data. The candidate service data refers to service data that is to be determined for displaying to the user.

In some embodiments, the service cloud platform may construct a query feature vector based on the constraint indicator and the user demand, search the service database for the candidate service data corresponding to one or more reference feature vectors whose similarity to the query feature vector satisfies a similarity condition, and count the one or more candidate service data into the candidate service pool. The similarity between vectors is negatively correlated with the vector distance, and the vector distance includes Euclidean distance.

In some embodiments, the service database includes a plurality of reference feature vectors and the candidate service data corresponding to each reference feature vector. The processor may construct the reference feature vectors based on historical constraint indicators and historical user demands in the historical data and take the historical service data displayed to the user in the historical data as the candidate service data corresponding to the reference feature vectors.

The similarity condition may include a similarity between the vectors that is greater than a second similarity threshold. The second similarity threshold may be preset based on the historical experience.

In some embodiments, the service cloud platform may further determine the similarity condition based on the quantity of constraint indicators, a current system load, and the historical user count of using the constraint indicator, and screen candidate service data satisfying the similarity condition from the service database based on the constraint indicator and the user demand, and count the screened candidate service data into the candidate service pool.

The current system load refers to the current resource load of the service cloud platform. In some embodiments, the current system load may include a CPU processing load, a memory load, a disk read load, and a data transmission load. The service cloud platform may obtain the current system load from its own devices, such as the CPU and a disk.

The historical user count of using the constraint indicator refers to a count of users who have used the constraint indicator within a preset historical period. The preset historical period may be preset based on historical experience, for example, 5 minutes or 10 minutes before the current time.

In some embodiments, the service cloud platform may query a corresponding second similarity threshold in a first preset table based on a quantity of the constraint indicators, the current system load, and the historical user count of using the constraint indicator, thereby obtaining the similarity condition.

In some embodiments, the first preset table may be configured by personnel according to experience. The first preset table includes a plurality of sets of correspondence among the quantity of the constraint indicators, the current system load, the historical user count of using the constraint indicator, and the second similarity threshold. For example, the higher the current system load, the lower the second similarity threshold. As another example, the greater the quantity of constraint indicators and the higher the historical user count of using the constraint indicator, the lower the second similarity threshold.

In some embodiments, the service cloud platform may filter the candidate service data satisfying the similarity condition from the service database based on the constraint indicator and the user demand and count the filtered candidate service data into the candidate service pool. More descriptions regarding this part of the content may be found in the above text and the relevant descriptions thereof.

In some embodiments of the present disclosure, to avoid excessive computational burden caused by filtering, the system load can be effectively reduced and data processing efficiency can be improved by dynamically adjusting the similarity condition.

The matching degree refers to data that features the degree of matching between the candidate service data and the user demand.

In some embodiments, the matching degree may be determined in a plurality of ways. For example, for a single candidate service data, the service cloud platform may calculate the similarity between the type of service data in the candidate service data and the type of service data in the user demand and take the similarity as the matching degree corresponding to the candidate service data. More descriptions regarding the calculation of the similarity of service data types may be found in step 230 and the relevant descriptions thereof.

In some embodiments, the service cloud platform may also obtain the historical evaluation information of the user on a plurality of candidate service data and generate the matching degree based on the historical evaluation information. The service cloud platform obtains the historical evaluation information of the user on a plurality of candidate service data through the service data management model.

In some embodiments, the service cloud platform may generate the matching degree based on the historical evaluation information of a plurality of candidate service data. For example, the service cloud platform may calculate an average value of the historical evaluation information based on the historical evaluation information of a plurality of candidate service data and take the average value as the matching degree.

In some embodiments, the processor may take an average value or a weighted average value of the ratings for a plurality of data items in a single historical evaluation information as the rating corresponding to the single historical evaluation information and take an average value of the ratings corresponding to a plurality of historical evaluation information as the average value of the historical evaluation information.

In some embodiments, the weights for a plurality of data items in a single historical evaluation information may be different, and the weight of each data item may be determined according to user preferences set by the user.

In some embodiments, the service cloud platform may determine the matching degree based on the satisfaction degree. More descriptions regarding this part of the content may be found in FIG. 4 and the relevant descriptions thereof.

In some embodiments of the present disclosure, the matching degree can better reflect the true intentions of the user by determining the matching degree based on the historical evaluation information, thereby improving the accuracy of the subsequent second service data.

In 250, take one or more candidate service data whose matching degree satisfies a preset matching condition as one or more second service data, and present the one or more second service data to the user through the user platform.

The second service data refers to service data that is further determined to be presented to the user after the first service data does not satisfy the user demand. The content included in the second service data is similar to that included in the first service data, which is not described herein.

In some embodiments, the preset matching condition may include that the matching degree is higher than a matching degree threshold. The matching degree threshold is preset based on historical experience.

In some embodiments, the service cloud platform may determine the preset matching condition based on the industry to which the user belongs, matching failure records, and the quantity of the plurality of candidate service data.

In some embodiments, the service cloud platform may obtain the industry to which the user belongs from the user demand database, such as the machinery industry or the power industry.

The matching failure record may be a record of the user identifying the first service data or the second service data presented through the user platform as not needed (i.e., matching failure). In some embodiments, the matching failure record includes a count of matching failures within a first preset period. The first preset period may be preset based on historical experience.

In some embodiments, the service cloud platform may query a corresponding matching degree threshold in a second preset table based on the industry to which the user belongs, the matching failure record, and a plurality of candidate service data, and use the queried matching degree threshold as the matching threshold in the preset matching condition.

In some embodiments, the second preset table may be set based on historical experience and includes a plurality of sets of correspondence among industry, a count of matching failures, a count of the candidate service data, and the matching degree threshold.

In some embodiments of the present disclosure, by comprehensively considering the industry to which the user belongs, the matching failure record, and a count of candidate service data, the matching degree threshold can be intelligently adjusted to balance the breadth and precision of matching. For the industry where matching is prone to failure, the matching degree threshold is lowered to improve the success rate of matching. When there is abundant optional service data, the threshold is raised to recommend higher quality and more precise service data.

In some embodiments, the service cloud platform may send one or more of the second service data to the user platform and present the one or more of the second service data to the user through the user platform.

In some embodiments of the present disclosure, by acquiring the user demand and the constraint indicator, the required service data can be rapidly filtered, avoiding complex searches within massive amounts of data, thereby significantly improving matching speed. Furthermore, after the service data obtained through rapid filtering fails to satisfy the user demand, the service data with a higher matching degree to the user can be further filtered, thereby further enhancing the experience of the user.

FIG. 3 is an exemplary flowchart of acquiring the user demand and the constraint indicator according to some embodiments of the present disclosure. In some embodiments, a process 300 may be performed by the service cloud platform. As shown in FIG. 3, the process 300 includes the following steps.

In 310, receive basic perception information input by a user through a user platform.

More descriptions regarding the user platform and the user may be found in FIG. 1 and the relevant descriptions thereof.

The basic perception information refers to information directly input by the user. In some embodiments, the basic perception information may include enterprise information and product information, etc. The enterprise information may include an enterprise type, a production scale, products, a production capacity, a mode of production, a production resource configuration, etc. The product information may include an equipment type, an equipment name, a process type, and a material type.

In some embodiments, the basic perception information may further include a drawing or a document, and the service cloud platform may extract a key parameter from the drawing or the document through the industry large model and perform cross validation with other basic perception information.

The key parameter refers to data included in the drawing or the document. In some embodiments, the key parameter may include a tolerance, a material, and dimensions of the product in the drawing or the document.

In some embodiments, the service cloud platform may extract the key parameter from the drawing or the document through the industry large model.

The industry large model may be a large model configured for different industries. In some embodiments, the industry large model may include a Natural Language Processing (NLP) model and a Computer Vision (CV) model.

In some embodiments, the service cloud platform may obtain the industry large model corresponding to the industry to which the user belongs from a service model library. The service model library includes a plurality of industry large models corresponding to the different industries. The industry large model may be preset based on industry experience. More descriptions regarding the service model library may be found in FIG. 1 and the relevant descriptions thereof.

The cross validation refers to verifying whether other basic perception information matches the key parameter. In some embodiments, the matching may include identity of fields, consistency of values, or the like.

Merely by way of example, for the drawing input by the user, the service cloud platform extracts the key parameter "the size of the five-axis machining center is A1" through the industry large model, if the other basic perception information input by the user contains "the size of the five-axis machining center is A2", the service cloud platform determines that the other basic perception information does not match the key parameter.

In some embodiments, in response to the other basic perception information matching the key parameter, the service cloud platform may add the key parameter to the constraint indicator. In response to the other basic perception information not matching the key parameter, the service cloud platform may further issue a notification to the user through the user platform (e.g., "the drawing is inconsistent with the input information, please confirm").

In some embodiments of the present disclosure, the conflicting data can be promptly identified and prompted by performing cross-validation between the key parameter extracted from the drawing or the document and other basic perception information, thereby ensuring the accuracy of the constraint indicator.

In 320, extract the keyword from the basic perception information.

The keyword refers to a word related to the industry to which the user belongs and the user demand. For example, the keyword may include an industry, a location, a material, a process, etc.

In some embodiments, the service cloud platform may embed the basic perception information input by the user into an extraction instruction in a preset format and input the extraction instruction to a semantic analysis model, such as a Large Language Model (LLM), thereby utilizing the natural language processing capability of the semantic analysis model to extract the keyword. The extraction instruction may include types of keywords to be extracted, such as an industry, a location, a material, a process, etc.

In 330, generate a field generation instruction based on the keyword.

The field generation instruction refers to an instruction used to generate the preset field.

In some embodiments, the service cloud platform may retrieve the instruction fragments corresponding to the keyword from a preset fragment library based on the keyword and generate the field generation instruction by concatenating the instruction fragments corresponding to the keyword.

In some embodiments, the preset fragment library may be preset based on historical experience and include a plurality of instruction fragments and a plurality of fragment correspondences (i.e., the correspondence between the keyword and the instruction fragment).

Merely by way of example, if the keyword is "injection molding", the instruction fragment corresponding to "injection molding" in the preset fragment library is "for 'injection molding', generate the fields such as a count of cavities, a mold steel material, a gate type, and a demolding way".

In some embodiments, the service cloud platform may concatenate a plurality of instruction fragments in sequence to obtain the field generation instruction.

In 340, input the field generation instruction into the industry large model to obtain the preset field corresponding to the keyword.

The preset field refers to a field configured to prompt the user regarding the types of service data that need to be input. For example, the preset field may include a count of cavities, a mold steel material, a gate type, a demolding way, etc.

In some embodiments, the service cloud platform may input the field generation instruction into the industry large model corresponding to the industry to which the user belongs and utilize the natural language processing capability of the industry large model to obtain the preset fields corresponding to the keyword.

In 350, display the preset field through the user platform to guide the user to complete the information interaction according to the preset field, to acquire the user demand and the constraint indicator.

In some embodiments, the service cloud platform may send the preset field to the user platform, and the user platform displays the preset field to guide the user to complete information interaction (e.g., inputting information) according to the preset field, thereby acquiring the user demand and the constraint indicator.

In some embodiments, the service cloud platform may extract the user demand and the constraint indicator from the information input by the user according to the preset field, using natural language processing or other ways.

In some embodiments of the present disclosure, by utilizing the large language model, the keyword can be rapidly extracted from the original input information of the user. Based on the keyword, the field generation instruction is intelligently generated using a preset fragment library, and then the preset field for guiding user interaction is quickly obtained by the industry large model. The processing approach of the multi-stage and the multi-model avoids the computational burden of directly using a single model to process massive amounts of data, while ensuring the accuracy of the final generated preset field.

It should be noted that the foregoing descriptions of the process 200 and the process 300 are merely for example and illustration, and do not limit the scope of the present disclosure. To those skilled in the art, various modifications and alterations to the process 200 and the process 300 may be made with guidance from the present disclosure. However, such modifications and alterations remain within the scope of the present disclosure.

FIG. 4 is an exemplary schematic diagram of a matching model according to some embodiments of the present disclosure.

In some embodiments, as shown in FIG. 4, the service cloud platform is configured to predict the satisfaction degree of the user 430 on a plurality of the candidate service data through the matching model 420 based on a plurality of candidate service data 411, the historical evaluation information of other users on a plurality of candidate service data 412, the historical service data 413, the basic perception information 414, and the constraint indicator 415. The service cloud platform may determine the matching degree 440 based on the satisfaction degree 430.

More descriptions regarding the matching degree, the candidate service data, the historical evaluation information, the historical service data, the basic perception information, and the constraint indicator may be found in FIGS. 2-3 and the relevant descriptions thereof.

The other users may be users other than the current user.

The historical service data 413 input into the matching model may be the historical service data corresponding to the current user.

In some embodiments, the matching model may be a machine learning model. For example, the matching model may be a deep Neural Network (DNN) model, another custom model structure, or the like, or any combination thereof.

In some embodiments, the matching model may be obtained by the service cloud platform through model training. For example, the service cloud platform may train the matching model using a plurality of labeled training samples.

In some embodiments, the training sample may include sample service data of a sample user, a sample historical evaluation information, a sample historical service data, a sample basic perception information, and a sample constraint indicator, and the label may include the satisfaction degree of the sample user on the sample service data. The sample historical evaluation information may be the historical evaluation information of users other than the sample user on the sample service data. The sample historical service data may be the historical service data corresponding to the sample user.

In some embodiments, the training samples may be generated based on the historical data. For example, the service cloud platform may use the candidate service data, the sample basic perception information, and the sample constraint indicator determined at a first historical time from the historical data as the sample service data, the sample basic perception information, and the sample constraint indicator, respectively; and use the historical user corresponding to the sample constraint indicator as the sample user. The service cloud platform uses the historical service data of the sample user at a second historical time and the historical evaluation information of other historical users (other than the sample user) on the sample service data as the sample historical service data and the sample historical evaluation information, respectively. The first historical time is later than the second historical time.

In some embodiments, the labels may be determined by the service cloud platform and/or through manual annotation. For example, the service cloud platform may use a ratio of the rating of the sample user on the sample service data to the number of times the sample user asks questions again within a second preset period after the sample service data is presented as a first label. The second preset period may be preset based on historical experience.

In some embodiments, the service cloud platform may input the training samples into an initial matching model, construct a loss function based on the satisfaction degree output by the initial matching model and the labels, update the parameters of the initial matching model based on the loss function, when preset condition is satisfied, complete the training of the initial matching model, and obtain the trained matching model. The preset condition may be that the loss function converges or that a count of iterations reaches a preset threshold.

In some embodiments, the service cloud platform may determine the satisfaction degree corresponding to the candidate service data as the matching degree corresponding to the candidate service data.

In some embodiments, in response to the user selecting at least one of the one or more second service data or ending the service interaction, the service cloud platform is configured to send the evaluation guidance information to the user by the user platform to guide the user to evaluate the one or more second service data to collect the evaluation information. The service cloud platform may use one or more second service data and the evaluation information as the training samples to train and/or update the matching model.

Ending the service interaction may refer to the user not selecting any of the second service data and choosing to end the service.

The evaluation guidance information refers to a prompt configured to guide the user to input the evaluation information. For example, the evaluation guidance information may be "Please rate the service data."

In some embodiments, the service cloud platform may obtain the evaluation information input by the user via the user platform.

In some embodiments, the service cloud platform may use one or more second service data as the sample service data in the training samples and use the evaluation information as the sample historical evaluation information corresponding to users other than the sample user in other training samples, to train and/or update the matching model.

In some embodiments of the present disclosure, the machine learning model is able to be incrementally trained and updated by using the second service data and the real-time evaluation information of the user as new training samples, thereby improving the prediction capability and accuracy of the model.

In some embodiments of the present disclosure, a deeper intelligent prediction of the matching degree between the user and the candidate service data can be achieved by using the machine learning model to comprehensively analyze the multidimensional information, thereby recommending the service data that is more likely to satisfy the user and enhancing the precision and personalization of the service.

The basic concepts have been described above. It is apparent that, for those skilled in the art, the foregoing detailed disclosure is merely exemplary and does not constitute a limitation on the present disclosure. Although not explicitly stated herein, persons skilled in the art may make various modifications, improvements, and corrections to the present disclosure. Such modifications, improvements, and corrections are suggested in this disclosure and therefore remain within the spirit and scope of the exemplary embodiments of the present disclosure.

Finally, it should be understood that the embodiments described in the present disclosure are intended only to illustrate the principles of the embodiments of the present disclosure. Other variations may also fall within the scope of the present disclosure. Accordingly, alternative configurations of the embodiments of the present disclosure should be considered consistent with the teachings of the present disclosure, by way of example and not limitation. Therefore, the embodiments of the present disclosure are not limited to those explicitly presented and described herein.

What is claimed is:

1. A wide-area cloud manufacturing industrial service system based on an Internet of Things (IoT) large model, comprising: a service cloud platform and a user platform, wherein the service cloud platform is configured to:
acquire a constraint indicator through the user platform;
determine first service data from historical service data corresponding to a user based on the constraint indicator;
in response to a determination that the first service data satisfies a user demand, display the first service data to the user through the user platform;
in response to a determination that the first service data does not satisfy the user demand,
determine a candidate service pool from a service database based on the constraint indicator and the user demand, and generate a matching degree between each of a plurality of candidate service data in the candidate service pool and the user demand; and
take one or more candidate service data whose matching degree satisfies a preset matching condition as one or more second service data and present the one or more second service data to the user through the user platform.

2. The system according to claim 1, wherein the service cloud platform is further configured to:
determine a similarity condition based on a quantity of constraint indicators, a current system load, and a historical user count of using the constraint indicator; and
screen candidate service data satisfying the similarity condition from the service database based on the constraint indicator and the user demand and count the candidate service data into the candidate service pool.

3. The system according to claim 1, wherein the preset matching condition is determined based on an industry to which the user belongs, a matching failure record, and a quantity of the plurality of candidate service data.

4. The system according to claim 1, wherein the service cloud platform is further configured to:
receive basic perception information input by the user through the user platform, wherein the basic perception information comprises a field;
extract a keyword from the basic perception information;
generate a field generation instruction based on the keyword;
input the field generation instruction into an industry large model to obtain a preset field corresponding to the keyword; and
display the preset field through the user platform to guide the user to complete information interaction according to the preset field, to acquire the user demand and the constraint indicator.

5. The system according to claim 4, wherein the basic perception information further comprises a drawing or a document, and the service cloud platform is further configured to:
extract a key parameter from the drawing or the document through the industry large model and perform cross validation with other basic perception information.

6. The system according to claim 1, wherein the service cloud platform is further configured to:
acquire historical evaluation information of the user on the plurality of candidate service data; and
generate the matching degree based on the historical evaluation information.

7. The system according to claim 6, wherein the service cloud platform is further configured to:
predict a satisfaction degree of the user on the plurality of candidate service data through a matching model based on the plurality of candidate service data, historical evaluation information of other users on the plurality of candidate service data, the historical service data, the basic perception information, and the constraint indicator, wherein the matching model is a machine learning model; and
determine the matching degree based on the satisfaction degree.

8. The system according to claim 7, wherein the service cloud platform is further configured to:
in response to the user selecting at least one of the one or more second service data or ending service interaction, send evaluation guidance information to the user through the user platform to guide the user to evaluate the one or more second service data to collect evaluation information; and
use the one or more second service data and the evaluation information as training samples to train and/or update the matching model.

9. A wide-area cloud manufacturing industrial Internet of Things service method based on an Internet of Things (IoT) large model, wherein the method is performed by a service cloud platform of a wide-area cloud manufacturing industrial service system based on an IoT large model, and the method comprises:
acquiring a constraint indicator through a user platform;
determining first service data from historical service data corresponding to a user based on the constraint indicator;
in response to a determination that the first service data satisfies a user demand, displaying the first service data to the user through the user platform;
in response to a determination that the first service data do not satisfy the user demand,
determining a candidate service pool from a service database based on the constraint indicator and the user demand, and generating a matching degree between each of a plurality of candidate service data in the candidate service pool and the user demand; and
taking one or more candidate service data whose matching degree satisfies a preset matching condition as one or more second service data and presenting the one or more second service data to the user through the user platform.

10. The method according to claim 9, wherein determining the candidate service pool from the service database based on the constraint indicator and the user demand comprises:
determining a similarity condition based on a quantity of constraint indicators, a current system load, and a historical user count of using the constraint indicator; and
screening candidate service data satisfying the similarity condition from the service database based on the constraint indicator and the user demand and counting the candidate service data into the candidate service pool.

11. The method according to claim 9, wherein the preset matching condition is determined based on an industry to which the user belongs, a matching failure record, and a quantity of the plurality of candidate service data.

12. The method according to claim 9, wherein the method further comprises:
receiving basic perception information input by the user through the user platform, wherein the basic perception information comprises a field;
extracting a keyword from the basic perception information;
generating a field generation instruction based on the keyword;
inputting the field generation instruction into an industry large model to obtain a preset field corresponding to the keyword; and
displaying the preset field through the user platform to guide the user to complete information interaction according to the preset field, to acquire the user demand and the constraint indicator.

13. The method according to claim 12, wherein the basic perception information further comprises a drawing or a document, and the method further comprises:
extracting a key parameter from the drawing or the document through the industry large model and performing cross validation with other basic perception information.

14. The method according to claim 9, wherein generating the matching degree between each of the plurality of candidate service data in the candidate service pool and the user demand comprises:
acquiring historical evaluation information of the user on the plurality of candidate service data; and
generating the matching degree based on the historical evaluation information.

15. The method according to claim 14, wherein the method further comprises:
predicting, based on the plurality of candidate service data, historical evaluation information of other users on the plurality of candidate service data, the historical service data, the basic perception information, and the constraint indicator, a satisfaction degree of the user on the plurality of candidate service data by a matching model, wherein the matching model is a machine learning model; and
determining the matching degree based on the satisfaction degree.

16. The method according to claim 15, wherein the method further comprises:
in response to the user selecting at least one of the one or more second service data or ending a service interaction, sending, by the user platform, evaluation guidance information to the user to guide the user to evaluate the one or more second service data to collect evaluation information; and
using the one or more second service data and the evaluation information as training samples to train and/or update the matching model.
